(19) United States
(12) Patent Application Publication
(10) Pub. No.: US 2025/0143323 A1
(43) Pub. Date: May 8, 2025

(54) METHOD OF USING/APPLYING A KERATIN HYDROLYSIS PEPTIDE SOLUTION TO ENHANCE PRODUCTION YIELD OF TOMATO FRUITS UNDER HOT WEATHER CONDITION

(71) Applicant: CH Biotech R&D Co., Ltd., Nantou City (TW)

(72) Inventors: Iou-Zen CHEN, Taipei (TW); Hsin-Yu CHEN, Kaohsiung (TW); Jie-Chao YOU, New Taipei City (TW); Nai-Hua YE, Changhua (TW)

(73) Assignee: CH Biotech R&D Co., Ltd., Nantou City (TW)

(21) Appl. No.: 18/428,193

(22) Filed: Jan. 31, 2024

(30) Foreign Application Priority Data
Nov. 3, 2023 (TW) 112142535

(51) Int. Cl. A01N 63/50; A01N 25/02; A01P 21/00

(52) U.S. Cl. CPC A01N 63/50; A01N 25/02; A01P 21/00

(57) ABSTRACT

Present invention teaches the method of using a keratin hydrolysis peptide (“KHP”) solution to enhance tomato plant's growth and production yield in hot weather. By selectively choosing specific weights of feathers and water, and treating the mixture to a high-temperature high-pressure hydrolysis process, the resulting solution is confirmed to contain at least 253 peptides and then infused to the soil in which the tomato seedlings/plants are planted; the solution can also be sprayed to the leaf surface of tomato plants. Optionally, the KHP solution can be diluted by water, as disclosed in the specification, for applying to the soil around the tomato seedlings/plants and for spraying to leaf surface of tomato plants.

### PRIORITY CLAIM TO FOREIGN APPLICATION

Applicant hereby makes priority claim to a Taiwan application, number 112142535, having the Taiwan filing date of Nov. 3, 2023.

### BACKGROUND OF THE INVENTION

Present invention disclosed and claimed the method and application of a keratin hydrolysis peptide (“KHP”) solution for enhancing the production yield of tomato fruits in hot weather, high temperature condition, by using the thermally hydrolyzed feather keratin peptide solution to the soil when the tomato seeds are sowed as well as spraying to the leave's surface of young tomato plants and to the leaves surface of grown tomato plants at their fruit setting stage.

The KHP solution is made by a hydrolysis process using feathers and water, via a high-temperature and high-pressure process, resulting in a solution that has many beneficial applications in the fields of horticulture, agriculture and potentially other farming businesses.

Hydrolyzed keratin has long been used to strengthen hairs, reduce hair splitting and breakage. Other beneficial uses include skin moisturization and wound healing. Keratin hydrolysate has also been known to function as a biofertilizer, boosting plants' growth by enhancing the plants' ability to receive and utilize nutrients, including commonly applied fertilizers.

Tomato is one of the most popular fruits, also consumed as vegetables. It grows well in relatively cool temperature in many parts of the world. By the same token, it does not grow well when the growing seasons become hotter where the environmental temperatures are higher than normal.

With the unstoppable trend of climate change and global warming, it is anticipated that a global average temperature rise of 2-5° C. would lead to drastic reduction of tomato fruit yield due to the high temperature condition adverse to tomatoes. Studies have shown that when night time temperature exceeds 21° C., substantial reduction of tomato yield would become unavoidable.

In recent years, the day time/night time temperatures exceeding 32° C. and 24° C. are constantly observed between May and September in Taiwan. This type of hot weather is severely impacting the tomato farming and production.

Many researches have been done to improve or create better growth environment for tomatoes, or modify tomatoes' temperature-attribute that can adapt to hotter weather where high temperature readings have become normal There are no easy, cost-effective resolution, so far.

The present invention's KHP solution and the method of using same is a cost-effective way to the problems stated herein. The inventor's field tests, as discussed herein, confirmed the effectiveness of applying the KHP solution to enhance the tomato's production yield in a high temperature condition.

### SUMMARY OF THE INVENTION

The keratin solution is primarily based upon feather, which contains 85-91% keratin, 13-15% organic nitrogen, 1.6-2% organic sulfur, as well as other materials. The high keratin content has drawn many prior researches that work to break down, by enzyme, chemical agents, or fermentation process, into peptides, amino acids and other smaller molecules that can be used for animal feeds, plant fertilizers, and cultivation bases.

Around 2019, Nurdiawati, et al, came up with a hydrolysis process, by the mixture of α-amylase and protease to hydrolyze feather waste, resulting in a mixture of amino acids, fatty acids, and sugars. Nurdiawati experimented and adopted certain specific high-temperature and high-pressure setting in the hydrolysis process and discovered that the resulting solution, when mixed with some potassium and other minerals, can boost the growth of Pogostemon cablin and Vigna radiata, as reported in International Journal of Recycling or Organic Waste in Agriculture (8:221-232, 2019).

The inventors of present application, under the aegis of CH Biotech, developed and selected different feather and water compositions to perform the hydrolysis at higher temperature and higher pressure setting, resulting with different keratin hydrolysis peptide (“KHP”) solution that can be used on different crops/plants.

The selected embodiment of present invention uses a mixture of water and feathers, and subject the mixture to a thermal hydrolysis process to create KHP solutions based upon temperature/pressure parameters as noted below.

The inventors used the spectrometer Dionex UltiMate 3000 UPLC to separate the peptides; an analysis is done via Thermo Orbitrap Fushion Lumos Tribrid Orbitrap mass spectrometry to identify the peptides, which are then subsequently confirmed by looking up the BIOPEP-UWM database.

The solutions are infused to the soil in which the tomato seedlings/plants are planted. Alternatively, the solutions can be sprayed to the leaf surface of the tomato plants.

The solution can be diluted by water, at 50 to 1000 ratio by volume, and then applied to the soil in which the tomato seedlings/plants are planted, and sprayed to the leaf surface of tomato plants.

### BRIEF DESCRIPTION OF DRAWINGS

The accompanying drawings, figures and tables, which are incorporated in and constitute a part of this specification, illustrate and exemplify the preferred embodiments of the invention. Together with the description, serve to explain the principles of the invention.

Table I shows the at least 253 peptides and its annotated sequences for the solution generated in accordance with the disclosure of this application.

FIG. 1A shows the comparison of stem widths among the check group (CK, using water only), KHP-1 100× group (100 times dilution by water, soil infusion) and KHP-2 500× group (500 times dilution by water, leaf spray).

FIG. 1B shows the comparison of leaf lengths among the check group (CK), KHP-1 100× group and KHP-2 500× group.

FIG. 2A shows the comparison of leaf surface areas among the check group (CK), KHP-1 100× group and KHP-2 500× group.

FIG. 2B shows the comparison of chlorophyll counts among the check group (CK), KHP-1 100× group and KHP-2 500× group.

FIG. 2C shows the comparison of leaf thickness among the check group (CK), KHP-1 100× group and KHP-2 500× group.

FIG. 3A shows the comparison of fruiting branches among the check group (CK), KHP-1 100× group and KHP-2 500× group.

FIG. 3B shows the comparison of per branch fruit counts among the check group (CK), KHP-1 100× group and KHP-2 500× group.

FIG. 3C shows the comparison of per plant fruit weights among the check group (CK), KHP-1 100× group and KHP-2 500× group.

FIG. 4A shows the comparison of sellable fruit (>100 g) counts among the check group (CK), KHP-1 100× group and KHP-2 500× group.

FIG. 4B shows the comparison of Brix readings among the check group (CK), KHP-1 100× group and KHP-2 500× group.

FIG. 4C shows the comparison of fruit density among the check group (CK), KHP-1 100× group and KHP-2 500× group.

### DETAILED DESCRIPTION OF THE INVENTION

The keratin hydrolysis peptide (“KHP”) solution of present invention is made by a high-temperature and high-pressure process to treat a mixture of water and feathers as shown in the parameters herein.

The mixture ratio, temperature, pressure and duration parameters are shown herein:

| | Feather | Water | Water content | Pressure | Temp. | Time | Mass | Concen. |
|---|---|---|---|---|---|---|---|---|
| | (kg) | (kg) | in feather (%) | (kg/cm²) | (° C.) | (min) | (Da) | (ppm) |
| KHP-1 | 66 | 44 | 50% | 16 | 195 | 40 | 593.3~3828.0 | 200000 |
| KHP-2 | 50 | 40 | 50% | 12 | 185 | 80 | 593.3~3508.9 | 301500 |

The hydrolysis process, in the first embodiment (KHP-1) takes the steps of:
a. Preparing the KHP solution by mixing 66 kg of feathers whose content is 50% water and 44 kg of water in a sealed container;
b. hydrolyzing the mixture in the container with a temperature and pressure setting of 195° C. and 16 kg/cm² for a duration of 40 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm; and

The hydrolysis process, in the second embodiment (KHP-2) takes the steps of:
a. Preparing the KHP solution by mixing 50 kg of feathers whose content is 50% water with 40 kg of water in a sealed container;
b. hydrolyzing the mixture in the container with a temperature and pressure setting of 185° C. and 12 kg/cm² for a duration of 80 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm;

The confirmation of some of the 253 peptides is further done by referencing the BIOPEP-UWM database.

The solution can then be applied to the soil in which the tomato seedlings/plants are planted, as well as spraying to the leaf surface of the young tomato plants; the application of the solution can be done until the fruit setting stage.

The method of using a keratin hydrolysis peptide (KHP) solution stated above further causes the solution to be diluted with water by volume at the ratio of 1:50-1000 for applying to the soil in which the tomato seedlings/plants are planted, or spraying to the leaf's surface of the young tomato plants; the application of the solution can be done until the fruit setting stage.

To test the effectiveness of the KHP solution made by the steps disclosed herein, the inventors use both embodiments, with different dilution ratios as noted:
KHP-1 100× denotes using KHP-1 solution with water dilution of 100 times. The KHP-1 100× is infused into the soil in which the tomato seedlings/plants are planted.
KHP-2 500× denotes using KHP-2 solution with water dilution of 500 times. The KHP-2 500× is sprayed to the leaf surface of tomato plants.

To test the effectiveness of the KHP solution as made and applied to tomato plants, the inventors chose the tomato species of ChuanFu 993, planted them in 60 normal grown pots, for each of the three (3) groups: check group (CK) where only water is given, KHP-1 100× group of soil infusion and KHP-2 500× group of leaf spray.

Seeds are planted in plug trays for seedlings to grow. Twenty-One (21) days after planting the seeds, the seedlings are transplanted into soil.

7 days after the transplantation, the first KHP application of soil infusion is carried out in the KHP-1×100 group and the first KHP leaf spray is done to the KHP-2×500 group, weekly for the next 11 weeks, reaching the fruit setting stage.

On the 14^{th} day and the 21^{st} day after the transplantation, plants were analyzed for such measurements of stem width, leaf length, leaf thickness, chlorophyll, etc. to compare the KHP application effectiveness.

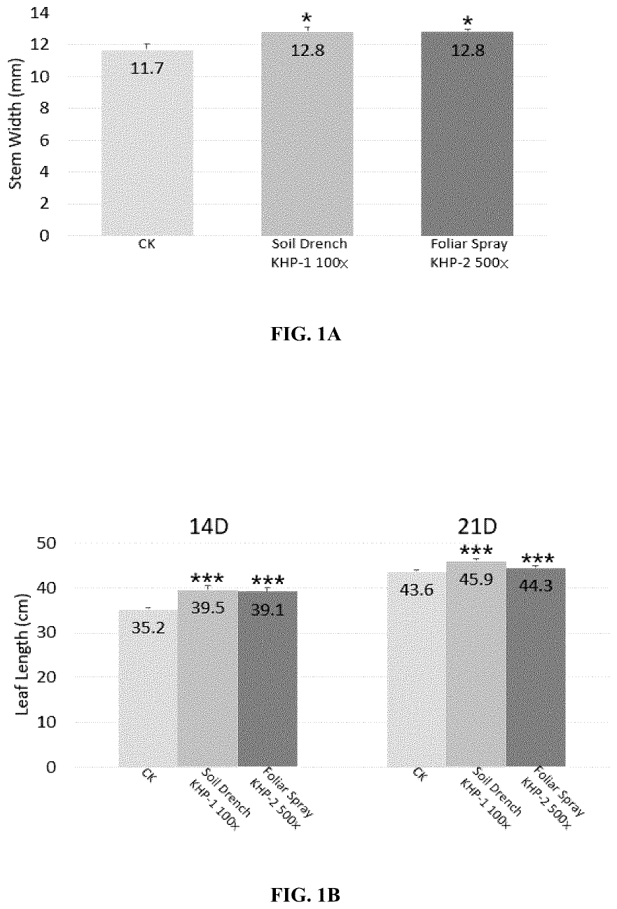

On the 21^{st} day after transplantation, the stem width under the third node was measured for all the plants. The average width (measured in mm) for each group is then noted and shown in FIG. 1A. As can be seen, the two groups with KHP solution treatment have better stem width numbers than that of the check group (CK).

On the 14^{th} and the 21^{st} days, the length of the seventh leaf is measured; the average number for each group is then noted and shown in FIG. 1B. As can be seen, the two groups with KHP solution treatment show better leaf growth and the length is clearly longer than that of the check group.

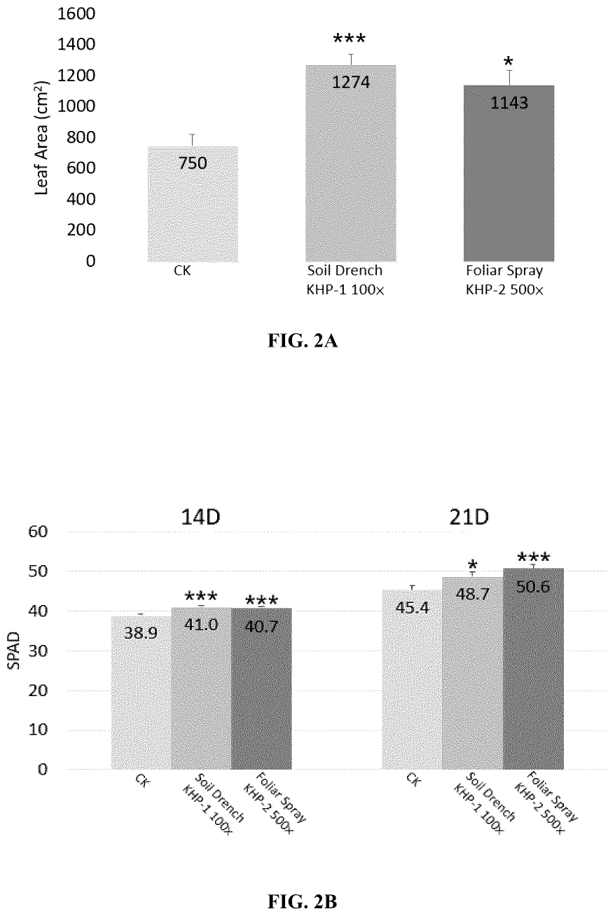

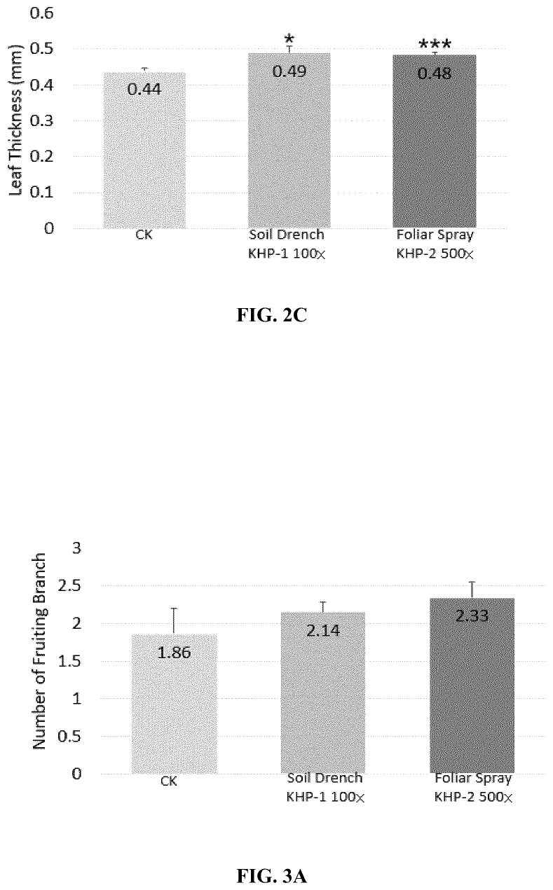

On the 21^{st} day, the seventh leaf from each tomato plant is retrieved and scanned using WinFOLIA Pro LA2400 (Regent) to compute leaf surface area. The results are noted and tabulated in FIG. 2A. As can be seen, the two KHP solution groups have substantially larger leaf area than that of the check group.

On the 14^{th} and the 21^{st} day, the seventh leaf retrieved from each plant is measured by a SPAD 502 plus instrument to get the chlorophyll counts; the results, averaged from all the plants in the group are noted in FIG. 2B. As can be seen, the two KHP solution groups have better chlorophyll counts measured at two different times than the check group.

On the 21^{st} day, the seventh leaf from each tomato plant is retrieved and the thickness is measured. The results are noted and tabulated in FIG. 2C. As can be seen, the two KHP solution groups have thicker leaves than the check group's leaves.

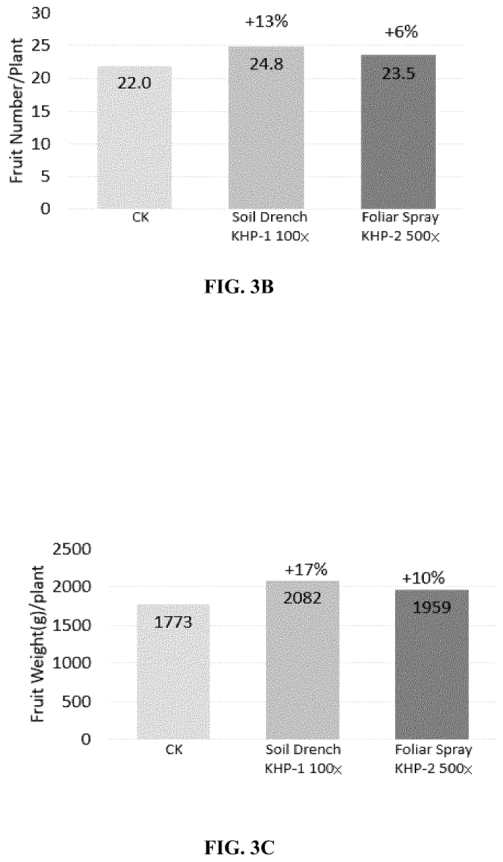

Around fruiting time, the number of fruiting branches from the 3 groups are counted and resulted noted in FIG. 3A. As can be seen, both the KHP solution groups have more fruiting branches than the check group.

Around fruiting time, the number of fruits per branch from the 3 groups are counted and averaged, the results are noted in FIG. 3B. As can be seen, the two KHP solution groups' per-branch fruit counts are substantially higher than that of the check group.

Around fruiting time, the fruit weights per plant from the 3 groups are measured and averaged, the results are noted in FIG. 3C. As can be seen, the two KHP solution groups' fruit weights per plant are substantially higher than that of the check group.

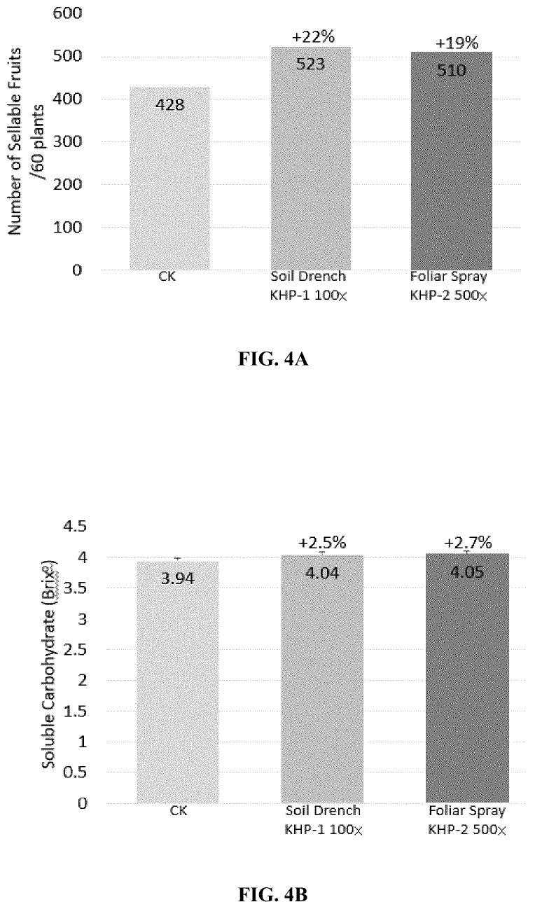

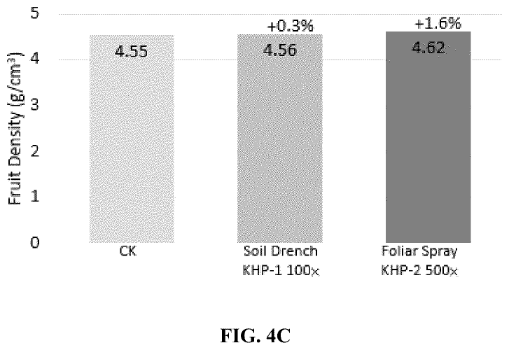

Around fruiting time, the sellable fruit (fruit weight larger than 100 g is deemed sellable) counts from the 3 groups are counted and averaged, the results are noted in FIG. 4A. As can be seen, both KHP solution groups have higher sellable fruit counts than that of the check group, with the KHP-1 100× group shows a significant 22% increase.

Around fruiting time, the fruit sweetness (measured in Brix number) from the 3 groups is measured and averaged; the results are noted in FIG. 4B. As can be seen, both KHP solution groups have better sweetness readings in Brix numbers.

Around fruiting time, the fruit weight density (measured in g/cm³) from the 3 groups are measured and averaged; the results are noted in FIG. 4C. As can be seen, the KHP-1 100× group shows 0.3% increase and the KHP-2 500× group shows 1.6% increase.

As has been proven by the field tests, and the scientific analysis/measurement done by the inventors, the method of creating the KHP solution and the method of application to will help with the growth and the production yield of tomato plants even at a higher temperature that is adverse to the tomato's natural growth and development.

While the disclosure herein gave limited teachings and embodiment examples, it should be noted that the description and disclosure made herein illustrated the preferred embodiments of the invention and are not meant to limit the scope of the applicant's rights. Variations and alterations may be employed for yet additional embodiments without departing from the scope of the invention herein.

1. A method of using a keratin hydrolysis peptide (KHP) solution to enhance the production yield of tomato fruits under hot weather condition, comprising the steps of:
a. Preparing the KHP solution by mixing 66 kg of feathers whose content is 50% water and 44 kg of water in a sealed container;
b. hydrolyzing the mixture in the container with a temperature and pressure setting of 195° C. and 16 kg/cm² for a duration of 40 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm; and
d. infusing the solution to the soil in which the tomato seedlings are planted.

2. The method of using a keratin hydrolysis peptide (KHP) solution of claim 1 where the solution is sprayed to tomato plant's leaf surfaces.

3. The method of using a keratin hydrolysis peptide (KHP) solution of claim 1 wherein the solution is diluted with water by volume at the ratio of 1:50-1000 for applying to the soil in which the tomato plants are planted.

4. The method of using a keratin hydrolysis peptide (KHP) solution of claim 2 wherein the solution is diluted with water by volume at the ratio of 1:50-1000 for spraying to tomato plant's leaf surfaces.

5. A method of using a keratin hydrolysis peptide (KHP) solution to enhance the production yield of tomato fruits under hot weather condition, comprising the steps of:
a. Preparing the KHP solution by mixing 50 kg of feathers whose content is 50% water and 40 kg of water in a sealed container;
b. hydrolyzing the mixture in the container with a temperature and pressure setting of 185° C. and 12 kg/cm² for a duration of 80 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm; and
d. infusing the solution to the soil in which tomato seedlings are planted.

6. The method of using a keratin hydrolysis peptide (KHP) solution of claim 5 where the solution is sprayed to tomato plant's leaf surfaces.

7. The method of using a keratin hydrolysis peptide (KHP) solution of claim 5 wherein the solution is diluted with water by volume at the ratio of 1:50-1000 for applying to the soil in which the tomato plants are planted.

8. The method of using a keratin hydrolysis peptide (KHP) solution of claim 6 wherein the solution is diluted with water by volume at the ratio of 1:50-1000 for spraying to tomato plant's leaf surfaces.
